(19) United States
(12) Patent Application Publication
(10) Pub. No.: US 2014/0058969 A1
(43) Pub. Date: Feb. 27, 2014

(54) SYSTEM, METHOD AND COMPUTER PROGRAM PRODUCT FOR NETWORKED FUNDRAISING AND COMMUNICATION

(71) Applicant: Edward J. Kane, Chicago, IL (US)

(72) Inventor: Edward J. Kane, Chicago, IL (US)

(21) Appl. No.: 14/011,426

(22) Filed: Aug. 27, 2013

Related U.S. Application Data
(60) Provisional application No. 61/693,498, filed on Aug. 27, 2012.

(51) Int. Cl. G06Q 30/02

(52) U.S. Cl. CPC G06Q 30/0279
USPC 705/329

(57) ABSTRACT

A system, method and computer program product for networked fundraising and communication includes a platform for conducting regional and even global fundraising events in real-time. Individuals and/or groups from different geographic areas can participate in real-time in the events via the internet. For some events, the system enables normalized competition. Plural organizations sponsor and/or conduct events utilizing the system. The system is flexible allowing organizations to set participant entry requirements and event rules. The system functions to collect the event proceeds which are distributed following the event.

### PRIORITY

This application claims priority to U.S. provisional patent application Ser. No. 61/693,498, filed Aug. 27, 2012.

### FIELD OF THE INVENTION

The present invention is directed towards a system, platform and method for networked fundraising and communication.

### BACKGROUND OF THE INVENTION

The inventor herein, Edward J. Kane suffers from amyotrophic lateral sclerosis, or ALS. Patients with ALS experience difficulty with movement. ALS patients and other disabled persons are frequently homebound without mobility assistance equipment such as walkers, braces, and manual and motorized wheelchairs. Patient homes have to be mobility adapted to provide grab bars, guard and safety rails, ramps, lifts, wider doorways, etc. Similarly, specially equipped vehicles are needed. Mobility assistance equipment and home adaptations can be very expensive. Government assistance through Medicare and other programs, company benefit programs and insurance coverage are often lacking or inadequate to provide the funds need for mobility assistance equipment and home adaptations.

Edward Kane is establishing a Foundation to support individuals suffering from ALS and other mobility disabilities. It is the mission of the Foundation to provide private funding for mobility assistance for patients suffering from ALS and other disabilities. Like other charities, the Foundation is engaged in raising funds to support its mission. Charities typically raise funds by conducting events, such as walkathons, runs, warrior dashes and other athletic events; golf, bowling, poker and other tournaments; card, video and other games; fantasy sport leagues; scavenger hunts; and the like (hereinafter “events”). Charity events are fun for the participants, build community and goodwill, and generate income for the charity.

Fundraising success is related to participation, which is frequently limited by the event location and capacity. For example, golf tournaments are conducted at a particular country club with a limited maximum number of participants. Restrictions on geographic location and number of participants limit the fundraising potential for such events.

The present disclosure addresses these and other problems in the art.

### SUMMARY OF THE INVENTION

In accordance with the invention, a fundraising system embodiment is provided for conducting multiple virtual and real events and raising funds for a plurality of organizations. The system comprises a platform resident on a server for offering a plurality of events hosted by a plurality of organizations respectively, wherein the platform is configured so that a plurality of participants in plural locations remote from each other can participate in the events. The system further includes a communication module coupled to the platform configured to accept participant data and to communicate event results, a registration module coupled to the platform for participant registration to events, a payment processing module coupled to the platform to accept payment from participants, an event processing module programmed to process data received from multiple sources relating to the conduct of the events and to determine event results, and a money transfer module to transfer event proceeds to the organizations.

In another embodiment of the invention, a method for conducting fundraising events for plural organizations comprises providing an online platform on a file server and configuring the platform to host a plurality of events provided by a plurality of organizations respectively, such that participants in plural locations remote from each other can participate in the events. An Internet website interface is provided coupled with the platform wherein participants can view and select from the plurality of events. The method provides for accepting participant registrations to selected events and processing payments from participants for the selected events. During the event, the method embodiment of the invention accepts data from at least one of the participant, the event sponsoring organization and a third party relating to the conduct of each event, and processes data on the conduct of events, preferably in real time or near real time. Event results and other relevant information are communicated to the participants. Finally, proceeds are distributed to the organizations, the Foundation retaining a commission.

A computer program product is yet another embodiment of the invention as described herein below.

The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1 is a schematic diagram of one embodiment of the system of the invention;

FIG. 2 is a functional block diagram of the present system featuring exemplary functional modules; and

FIGS. 3-7 illustrate an exemplary method in accordance with an embodiment of the present system.

### DETAILED DESCRIPTION OF THE PREFERRED EMBODIMENTS

Preferred embodiments of the present disclosure are described below by way of example only, with reference to the accompanying drawings. Further, the following description is merely exemplary in nature and is in no way intended to limit the disclosure, its application, or uses. As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. Thus, while this disclosure includes particular examples and arrangements of the modules, the scope of the present system should not be so limited since other modifications will become apparent to the skilled practitioner.

The present invention is directed towards a system, platform and method for networked fundraising and communication, embodiments of which will be hereinafter referred to simply as “the system” with the understanding that embodiments may include systems, methods and computer program products. The system provides a platform for conducting regional and even global fundraising events, e.g., a golf tournament, in real-time. Individuals and/or groups (“participants”) from different geographic areas can participate in real-time in the events via the internet. In some embodiments, the fundraising events take the form of a competition such as golf, bowling, running, auto-racing; fantasy sports, such as football, baseball, soccer, rugby; or online games, such as video games, poker and the like. Other events can be non-competitive such as walkathons. Events can be virtual or real, or a combination thereof. As may be applicable to some sports, the system enables normalized competition to factor in participant skill levels (e.g., golf handicap), course ratings, local conditions, and other factors to balance the competition and level the playing field. The system includes a website, system software and database that are resident on a server linked to the internet. Relevant information can be stored in the database for subsequent retrieval, functioning as a data storage device and/or a machine readable data storage medium carrying data, computer programs, and the like.

One or more organizations sponsor and/or conduct events utilizing the system. In particular, a system host Foundation, as described above, sponsors events on the system including, for example, daily, weekly, monthly tournaments in multiple sports, best of four game tournaments, and annual events. Foundation competitive events typically include prizes/awards to winners, which can be issued via the system.

The system also provides a platform to third party charities and non-profit organizations to conduct their own fundraising events. The term “organizations” as used herein refers to the Foundation, other charities, non-profit organizations, and other individuals or groups that host, sponsor or conduct fundraising events. The system is adaptable to meet individual requirements or criteria set by each organization. The system functions to collect the event proceeds. In connection with such events, a portion of the proceeds will go to the host Foundation and the balance of the proceeds will go to the organization that is conducting the event.

Event participants can access the system via the internet using any suitable computing device with communication capability and a web browser, such as smart phones, PDA's, tablets and notebook computers. Participants and organizations can input information into the system via the internet. The system processes inputted information, information drawn for third-party sources, and information stored within system, and outputs data to participants and organizations in real-time or near real-time. For example, in connection with a national or regional golf tournament, normalizing factors such as handicaps, course ratings and slope, and local conditions can be input into the system. As the tournament progress, the scores of participants can be inputted, and the system then outputs leader boards, scores and other information in real-time or near real-time.

The system further provides means for individuals and groups participating in the events to make donations directly to the Foundation or their designated charity or non-profit organization. The system includes interactive communications for text, data, voice, images and video. The host Foundation and other organizations can communicate with participants and others, such as vendors and hosting venues. Participants can communicate directly with other participants in real-time or near real-time by text, email or social networks. The system also provides for advertising and marketing communications. Further features of the system include an online store, e.g., pro shop, practice events, blogs, click through portals to other websites, special “members only” areas, or premium offerings to participants.

In one embodiment of the system, many participants in different geographic areas can participate in a single fundraising event, e.g., participants in Chicago, New York, and Los Angles can simultaneously compete in a bowling tournament event. In another embodiment, Chicago and New York chapters of an organization can compete in the same event, e.g., a 5K run. In yet another embodiment, the event has a main location, e.g., a Chicago celebrity golf tournament, with many other individuals participating at designated, pre-approved courses throughout North America. If a charity or non-profit organization desired to conduct a worldwide golf tournament, for example, it may be preferable for the tournament to be broken up into multiple regions, each region comprising 1-3 time zones. Within each region, participants would compete in real-time. Via the system, a charity or other organization can greatly increase the level of participation in its events and thereby dramatically increase revenue.

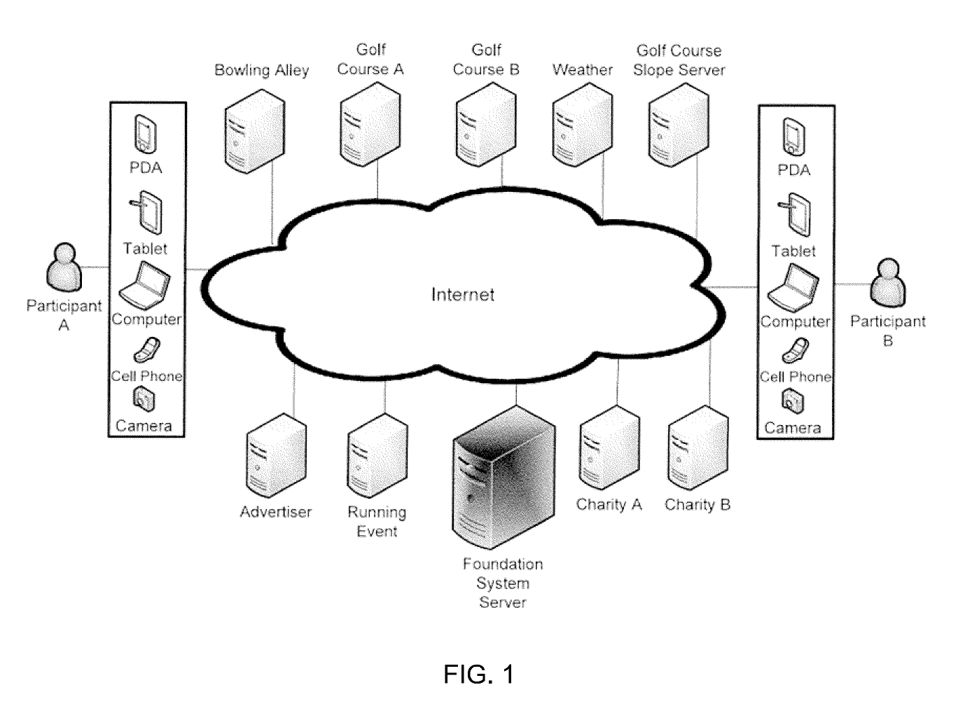

FIG. 1 is a schematic diagram of one embodiment of the system. A system server is provided that is in communication with the internet or cloud. Multiple charities, i.e., Charity A and Charity B, are linked to the system server via the internet, whereby the system server provides a platform for their events. An application programming interface (API) is preferably included to allow the charity to directly link to the system server. Multiple event venues are also linked via an API, including for example, multiple golf courses, bowling alleys and running events. The system is also configured to draw data from third party sources, such as golf course slope server and weather bureaus. Multiple participants, shown diagrammatically as Participant A and Participant B, connect to the system via the cloud using their preferred devices, e.g., pda, tablet, computer, smart phone, camera. The system is preferably configured to recognize the device being used by the participant and generate content based thereon. For example, participants using mobile devices will view content tailored to the devices. Further, the system preferably includes mobile application software (mobile apps) that participants and other users can download for their handheld devices. Further features of the invention will be apparent from the following embodiments.

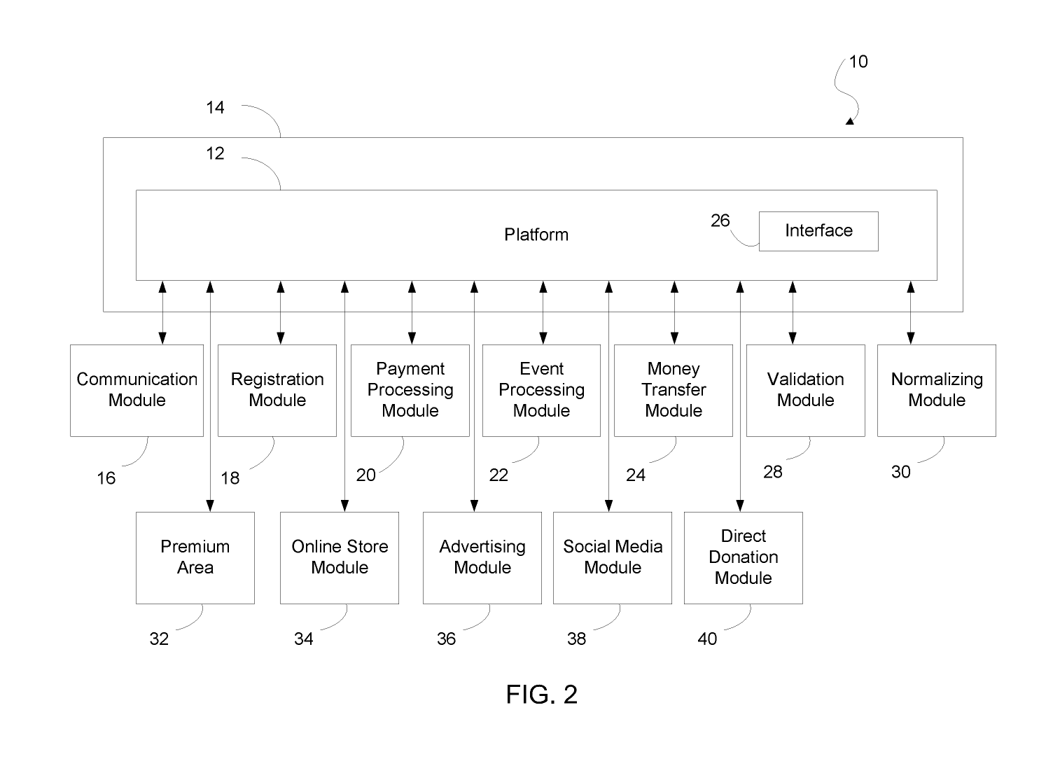

FIG. 2 is a functional block diagram of one embodiment of the system. A fundraising system is generally designated 10, and is provided for conducting multiple virtual and real events and raising funds for a plurality of organizations. A platform 12 resident on a server 14 for offering a plurality of events hosted by a plurality of organizations respectively, wherein the platform 12 is configured so that a plurality of participants in plural locations remote from each other participate in the events. A communication module 16 coupled to the platform 12 is configured to accept participant data and to communicate event results. A registration module 18 is also coupled to the platform 12 for participant registration to events. Further, a payment processing module 20 is coupled to the platform 12 to accept payments from participants. An event processing module 22 is programmed to process data received from multiple sources relating to the conduct of the events and to determine event results. A money transfer module 24 is programmed to transfer event proceeds to the organizations.

It is preferred that the platform 12 includes an interface 26 to connect with the organizations. In some cases, it is also contemplated that the platform 12 includes the interface 26 to connect with advertisers. Preferably, a validation module 28 is included in the system 10 for validating data relating to the conduct of the event. A normalizing module 30 is also included in the system 10 for normalizing participant scores. As discussed above, a premium area 32, such as the special “members only” area, and an online store 34, e.g., pro shop, are included in the system 10. It is also contemplated that an advertising module 36 is provided for advertising and marketing communication purposes. A social networking or media module 38 is provided for participant to participant communications during events. A donation module 40 is provided so that participants can donate to a selected organization or other charity, either by a direct or indirect method.

A few representative event embodiments follow.

### Embodiment 1

1. The system offers multiple competitive events (real and virtual) to enhance the fundraising efforts of the foundation and third party organizations.

2. The system permits participants navigate to the system website and log in.

3. The system provides participants with multiple event choices:
a. Charity events
b. Foundation events
c. Active participation events, e.g., golf, bowling, runs
d. Fantasy events, e.g., fantasy football and baseball leagues
e. Games

4. The system prompts participants for information applicable to the chosen event, e.g., golf handicap, age, gender, etc.

5. System confirms participant choices.

6. The system proves payment processing whereby participants pay entry fee via credit card or other third-party payment provider, or a previously established system account.

7. Performance:
a. Virtual and fantasy events:
   1. The system accepts participants entries
b. Real events:
   1. Data on the conduct of the event, e.g., participant's scores, are received by the system computer.
      a. By automatic transfer
      b. By manual input
   2. The system communicates optional advertising and other communications during the event, e.g., participant to participant text and video messaging.

8. Scoring:
a. The system processes data received from participants, the system data banks, venues and/or other sources; provides ongoing scores or other data during the event; and at the conclusion of the event computes and records scores and announces winners.

9. Prizes/Awards (if any)
a. Will be distributed by each organization or via the system.

10. Communications:
a. Separated channels for each event
b. Email and text messaging between participants and the system
c. End of year charitable donation letter

### Embodiment 2

### Golf Tournament

1. The system offers competitive events (actual and fantasy) to enhance the fundraising efforts of the foundation and various organizations.

2. The system permits participants enter the system website and log in.

3. The system provides choices for participants:
a. Charity events
b. Foundation events
c. Actual and simulated games

4. The system prompts participants for information applicable to the chosen event, e.g., golf handicap, age, gender, etc.

5. System confirms participant choices.

6. The system proves payment processing whereby participants pay entry fee via credit card or other third-party payment provider, or a previously established system account.

7. Performance:
a. Actual (Participatory) Event: Golf
   i. The system prompts participants to enter name of course via Smartphone, I-Pad, etc. into the system.
   ii. The system prompts participants to enter their handicap via smart phone, I-Pad, etc. into system via the website.

8. The system is configured to receive scores either by hole or at the end of 18 holes from the venue/course, independent scorers, or the participants themselves.

9. The system equalizes the scores utilizing predetermined normalization factors.

10. The system generates leader boards and communicates individual scores to all or selected participants and others.

11. Prizes/Awards (if any)
a. Via the system or otherwise the foundation or charity organization distributes prizes and awards.

12. Communications:
a. Separated channels for each event
b. Emails, text, video, images, etc. by and among participants, foundation, organizations, sponsors, and others.
c. End of year charitable donation letter

### Embodiment 3

### Bowling Tournament

1. The system offers competitive events (actual and fantasy) to enhance the fundraising efforts of the foundation and various organizations.

2. The system permits participants enter the system website and log in.

3. The system provides choices for participants:
a. Charity events
b. Foundation events
c. Actual and simulated games

4. The system prompts participants for information applicable to the chosen event, e.g., age, gender, etc.

5. System confirms participant choices.

6. The system proves payment processing whereby participants pay entry fee via credit card or other third-party payment provider, or a previously established system account.

7. Performance:
a. Actual (Participatory) Event: bowling
   i. The system prompts participants to enter name of a selected/designated bowling alley via smart phone, I-Pad, etc. into the system via the website.
   ii. The system connects to the venue, i.e. the lanes, via secure internet connection.
   iii. Scores are entered automatically in real-time, for example via an XBowling app.
   iv. Scores can be seen by the host and all participants.
b. The system can enable event set up as tournaments or leagues.

8. Prizes/Awards (if any)
a. Will be distributed by the foundation or organization via the system or otherwise.

9. Communications via the system:
a. Separated channels for each event
b. The system provides for emails between participants and foundation/organization.
c. End of year charitable donation letter

### Embodiment 4

### Third-Party Charity Event

1. The system invites fundraising organizations register with the system whereby the system functions as a platform for designated charitable events.

2. The system receives an event sponsoring organizations information and date concerning their event and posts it on the system.
a. The system enables the sponsoring organization to sets terms of admission to the event and other criteria.
b. Optionally, the event sponsoring organization can set qualifications for participants and/or designates venues.
c. Optionally, the sponsoring organization may have a local presence at each venue in addition to virtual presence through the system. The local chapter of the sponsoring organization can check participants into the event, provide participation gifts, provide a dinner ancillary to the event, etc.

3. The system controls and accepts participant registration.

4. The system provides choices for participants.

5. The system prompts participants for information applicable to the chosen event, e.g., age, gender, etc.

6. The system confirms participant choices.

7. The system proves payment processing whereby participants pay entry fee via credit card or other third-party payment provider, or a previously established system account.

8. The system accounts for fees/donations minus hosting fees, and communicates the same, preferably electronically sent to the fundraising organization.

9. The system provides marketing for the event sponsoring organization.

10. Performance:
i. Example Event: Golf
ii. The system prompts participants (or the sponsoring organization) to enter the name of each course via Smartphone, I-Pad, etc. into the system.
iii. The system prompts participants (or the sponsoring organization) to enter each participant' individual name and data, such as handicap via smart phone, I-Pad, etc. into system via the website.

11. The system is configured to receive scores either by hole or at the end of 18 holes from the venue/course, the sponsoring organization, or the participants themselves.

12. The system equalizes the scores utilizing predetermined normalization factors.

13. The system generates leader boards and communicates individual scores to all or selected participants and others.

14. Prizes/Awards (if any)
a. Will be distributed by the sponsoring organization directly or via the system.

15. Communications:
a. Separated channels for each event
b. Text, image, video and data communications between participants, the sponsoring organization and the foundation
c. End of year charitable donation letter

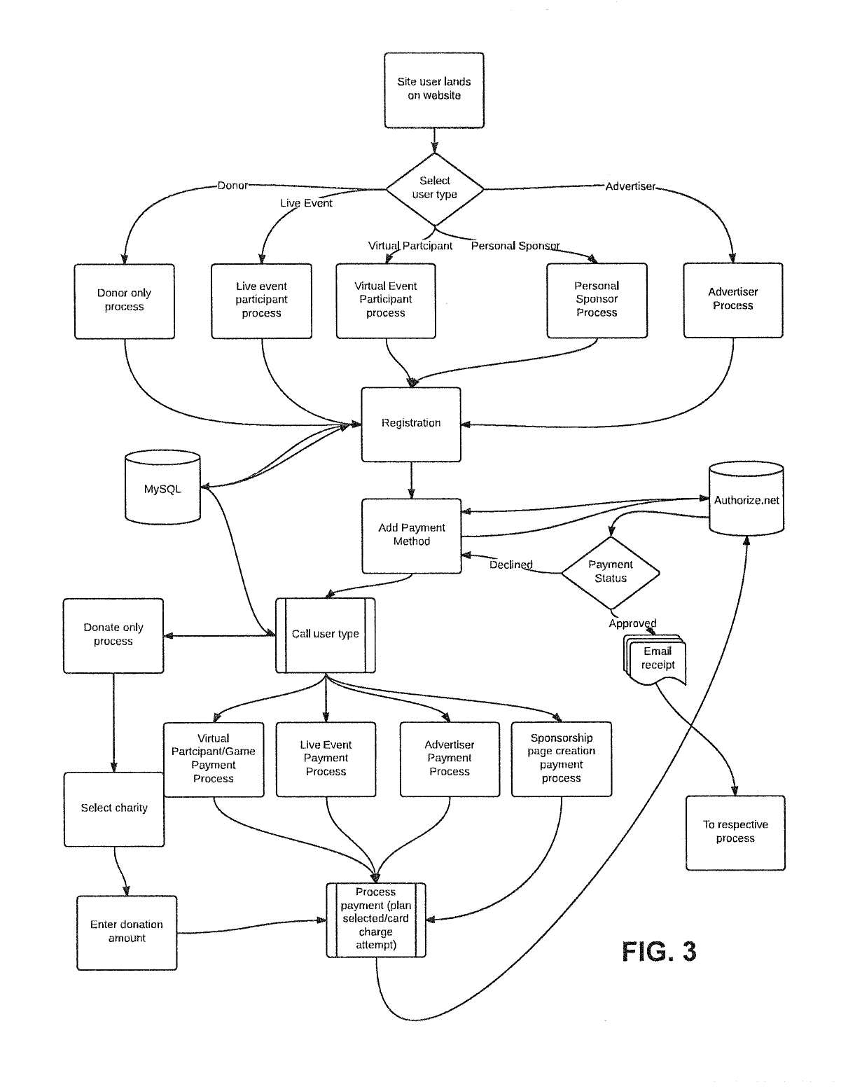

FIGS. 3-7 illustrate an exemplary method of networked fundraising and communication in accordance with an embodiment of the present system 10. Although the steps are primarily described with respect to the embodiments of FIGS. 1 and 2, it should be understood that the steps within the method may be modified and executed in a different order or sequence without altering the principles of the present disclosure.

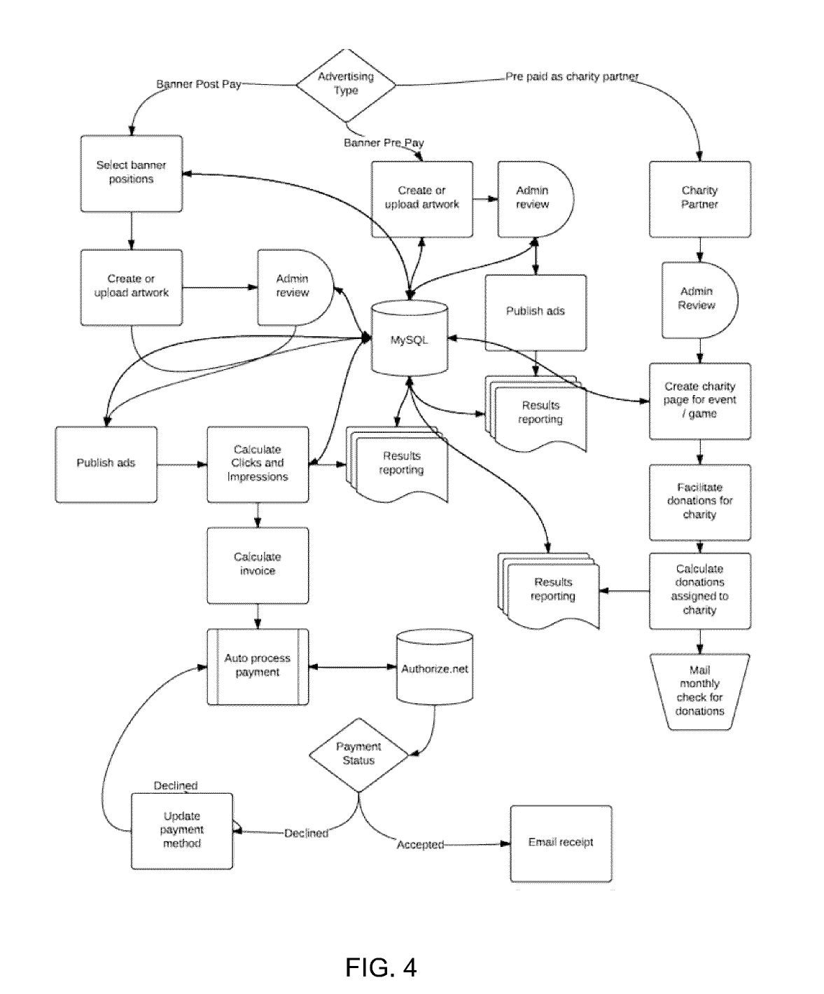

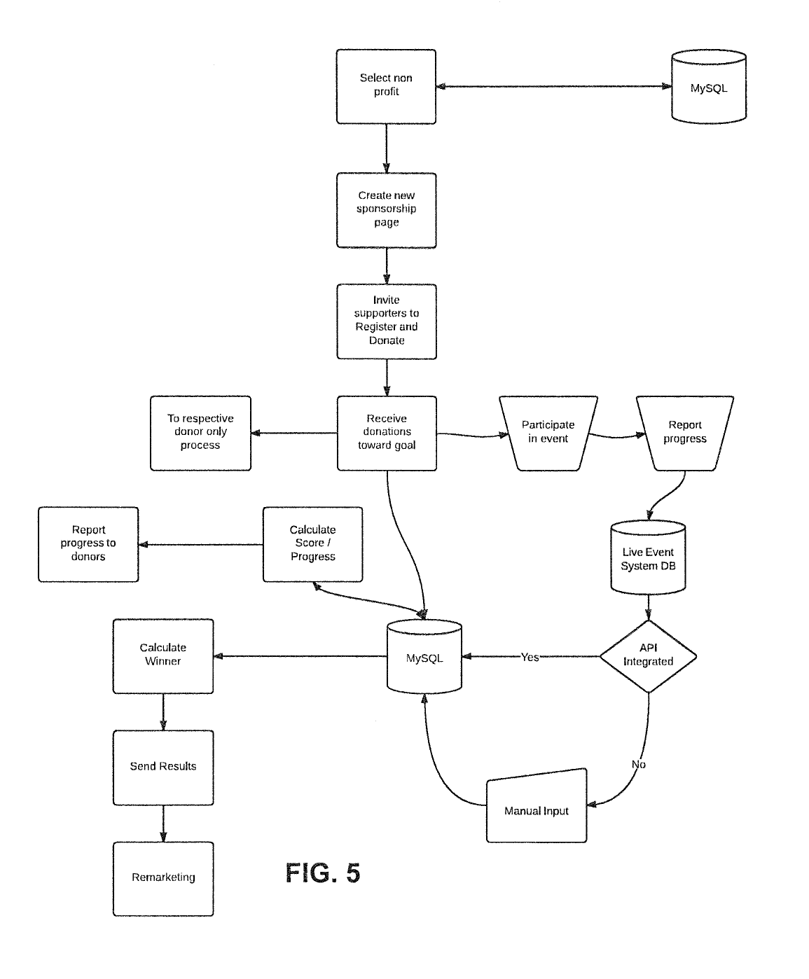

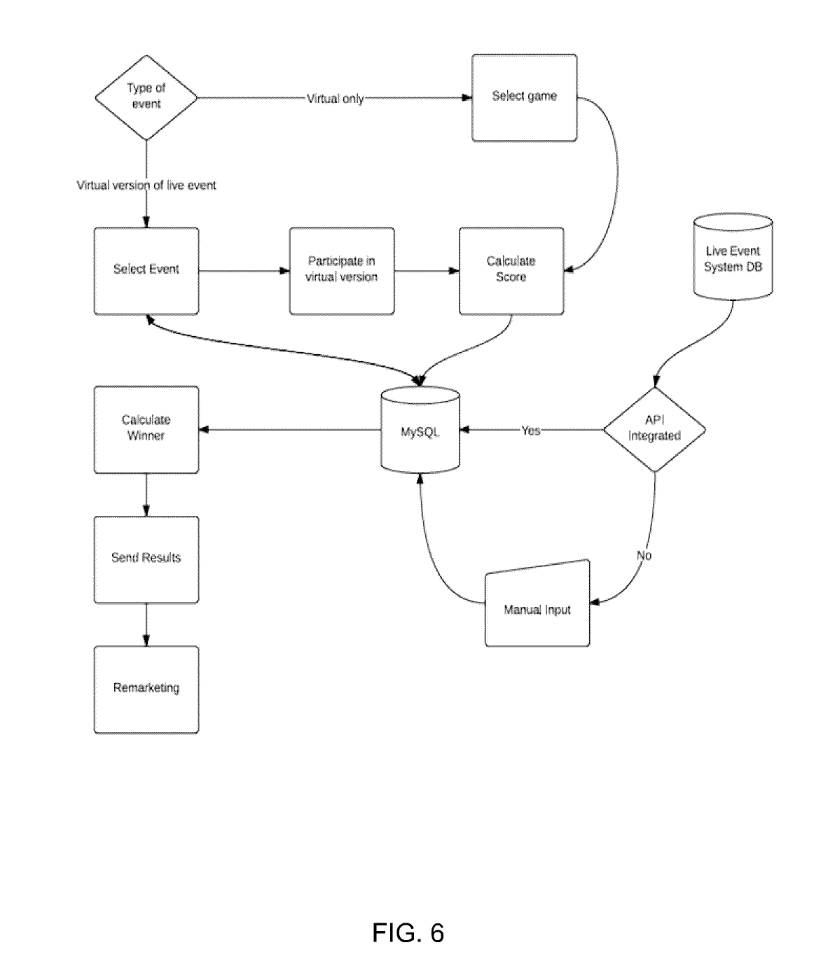

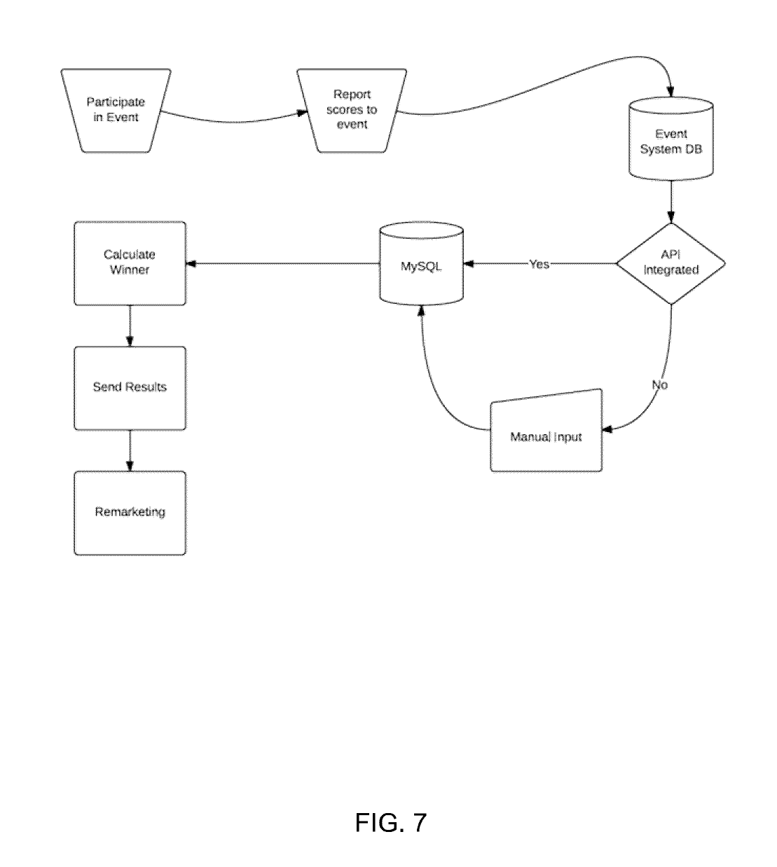

FIG. 3 illustrates an exemplary overall process of the present system 10. FIG. 4 illustrates an exemplary advertiser process of the present system 10. FIG. 5 illustrates an exemplary sponsorship process of the present system 10. FIG. 6 illustrates an exemplary virtual event process of the present system 10. FIG. 7 illustrates an exemplary live event participant process of the present system 10.

While preferred embodiments of the disclosure have been herein illustrated and described, it is to be appreciated that certain changes, rearrangements and modifications may be made therein without departing from the scope of the disclosure as defined by the appended claims.

What is claimed is:

1. A computer-implemented method for conducting fundraising events for plural organizations using a computer processor, comprising:
providing an online platform on a file server,
configuring the platform to host a plurality of events provided by a plurality of organizations respectively, such that participants in plural locations remote from each other can participate in the events,
providing a website coupled with the platform wherein participants view and select from the plurality of events,
accepting participant registrations to selected events,
processing payments from participants for the selected events,
accepting data from at least one of the participants, the event sponsoring organization and a third party relating to the conduct of each event,
processing data on the conduct of events,
communicating event results to the participants, and
distributing proceeds to the organizations.

2. The method of claim 1, wherein the platform configuring step includes allowing each organization to set terms for participant admission to its event and rules for the conduct of the event.

3. The method of claim 1, wherein at least one event is a virtual event.

4. The method of claim 1, wherein at least one event is a real event.

5. The method of claim 4, wherein the platform configuring step includes allowing each organization to designate plural venues for its real event, and the method further comprises the step of accepting verification from the organization of data relating to the conduct of the event.

6. The method of claim 5, wherein the real event is an athletic event and the method further comprises the step of normalizing participant scores.

7. The method of claim 1, wherein the step of accepting participant registrations includes prompting for participant information and confirming choices.

8. The method of claim 1, further comprising the step of communicating current event data to participants in real time or close to real time during the conduct of the event.

9. The method of claim 1, further comprising the step of awarding prizes to one or more participants.

10. The method of claim 1, further comprising the step of advertising to participants.

11. The method of claim 1, further comprising providing a communication link to participants configured for participant to participant communications during the event.

12. A fundraising system for conducting multiple virtual and real events and raising funds for a plurality of organizations, comprising:
a platform resident on a server for offering a plurality of events hosted by a plurality of organizations respectively, wherein the platform is configured so that a plurality of participants in plural locations remote from each other participate in the events,
a communication module coupled to the platform configured to accept participant data and to communicate event results,
a registration module coupled to the platform for participant registration to events,
a payment processing module coupled to the platform to accept one or more payments from participants,
an event processing module programmed to process data received from multiple sources relating to the conduct of the events and to determine event results, and
a money transfer module to transfer event proceeds to the organizations.

13. The system as in claim 12 wherein the platform includes an interface to connect with the organizations.

14. The system of claim 12 wherein the platform includes an interface to connect with advertisers.

15. The system of claim 12 further comprising a validation module for validating data relating to the conduct of the event.

16. The system of claim 12 further comprising a normalizing module for normalizing participant scores.

17. The system of claim 12 further comprising a donation module wherein participants can donate to a selected organization or other charity.

18. The system of claim 12 further comprising a social networking module for participant to participant communications during events.

19. A fundraising program recorded on a non-transitory computer-readable storage medium that will cause a computer to act as an event management device in a fundraising network, comprising
accepting event registration and configuration for a plurality of events provided by a plurality of organizations respectively,
accepting participant registrations to selected events,
processing payments from participants for the selected events,
accepting data from at least one of the participant, the event sponsoring organization and a third party relating to the conduct of each event,
processing data on the conduct of events,
communicating event results to the participants, and
distributing proceeds to the organizations.

20. The program of claim 19, further comprising allowing each organization to set terms for participant admission to its event and rules for the conduct of the event.
